(19) United States
(12) Patent Application Publication
(10) Pub. No.: US 2019/0051993 A1
(43) Pub. Date: Feb. 14, 2019

(54) BUSBAR UNIT AND ELECTRONIC DEVICE WITH BUSBAR UNIT

(71) Applicant: KYB Corporation, Tokyo (JP)

(72) Inventors: Tarou MATSUMAE, Tokyo (JP); Satoshi TAKEUCHI, Tokyo (JP); Kenji KONDA, Tokyo (JP)

(73) Assignee: KYB Corporation, Tokyo (JP)

(21) Appl. No.: 16/078,850

(22) PCT Filed: Jan. 11, 2017
(86) PCT No.: PCT/JP2017/000585

§ 371 Date: Aug. 22, 2018

(30) Foreign Application Priority Data
Mar. 30, 2016 (JP) 2016-068241

(51) Int. Cl. H01R 4/02; H01G 4/228; H01R 4/70

(52) U.S. Cl. CPC H01R 4/029; H01R 4/70; H01G 4/228

(57) ABSTRACT

A busbar unit includes a busbar connected by welding to a connection terminal of a ceramic capacitor and a molding part formed of the molding resin to cover the busbar, the busbar includes a body part covered by the molding part and a terminal part projecting from the molding part and connected to the connection terminal of the ceramic capacitor, and the molding part is formed with a guide hole to guide the connection terminal of the ceramic capacitor to bring the connection terminal into contact with or into proximity to the terminal part.

### TECHNICAL FIELD

The present invention relates to a busbar unit and an electronic device with a busbar unit.

### BACKGROUND ART

JP 2006-302543A describes an electrical component in which a component-side connection terminal of a busbar and a connection terminal of an electronic component are electrically connected by laser-welding tips of the component-side connection terminal of the busbar and the connection terminal of the electronic component.

### SUMMARY OF INVENTION

In welding the component-side connection terminal of the busbar and the connection terminal of the electronic component, it is necessary to position the connection terminal of the electronic component with respect to the component-side connection terminal of the busbar. The electrical component described in JP 2006-302543A is configured such that the tips of the component-side connection terminal of the busbar and the connection terminal of the electronic component are held in contact or in proximity only by housing the electronic component into a case body. However, in the electrical component of JP 2006-302543A, the component-side connection terminal of the busbar and the connection terminal of the electronic component may not be held in contact or in proximity depending on dimensional errors of each component, and the positioning of the component-side connection terminal of the busbar and the connection terminal of the electronic component was not sufficient.

The present invention aims to more precisely position a terminal part of a busbar and a connection terminal of an electronic component.

According to one aspect of the present invention, a busbar unit includes: a busbar connected by welding to a connection terminal of an electronic component; and a molding part formed of molding resin to cover the busbar; wherein the busbar includes: a body part covered by the molding part; and a terminal part projecting from the molding part and connected to the connection terminal of the electronic component; and the molding part is formed with a guide hole to guide the connection terminal of the electronic component to bring the connection terminal into contact with or into proximity to the terminal part.

### BRIEF DESCRIPTION OF DRAWINGS

FIG. 1 is a plan view showing a main part of an electronic device according to an embodiment of the present invention,

FIG. 2 is a bottom view showing the main part of the electronic device according to the embodiment of the present invention, and

FIG. 3 is a perspective view in section along line A-A of FIG. 1.

### DESCRIPTION OF EMBODIMENT

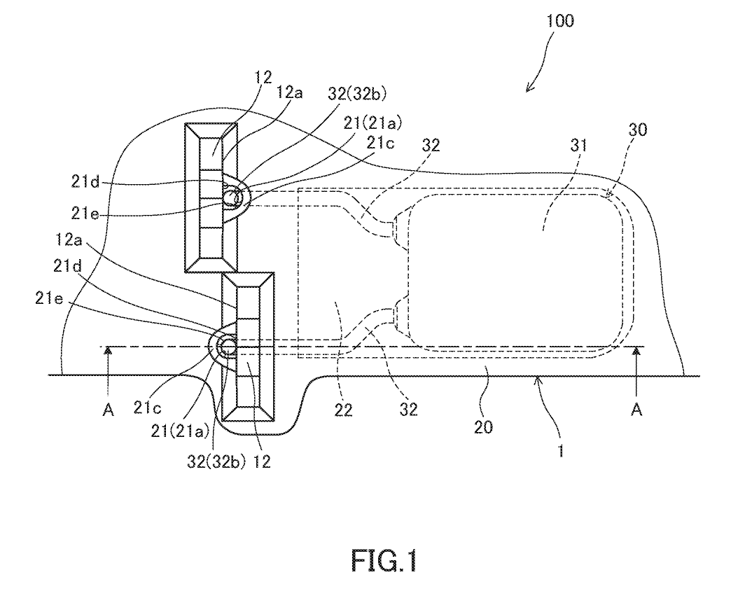

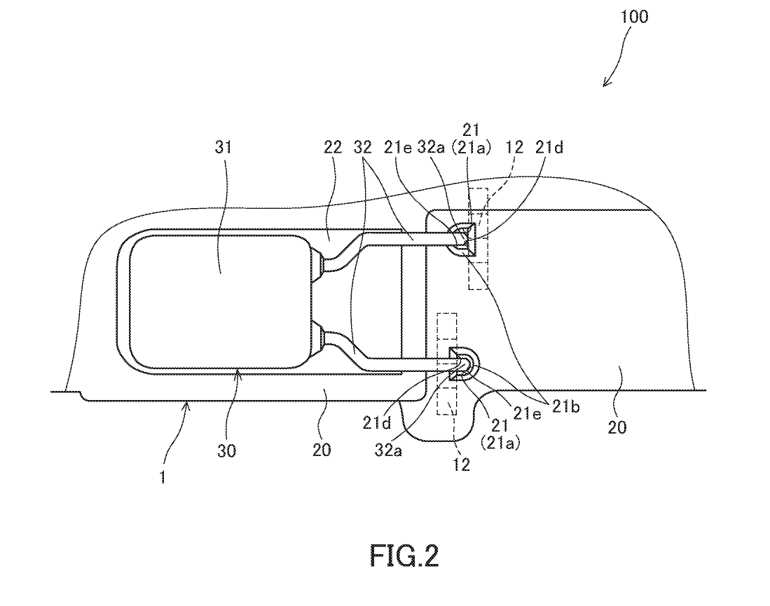

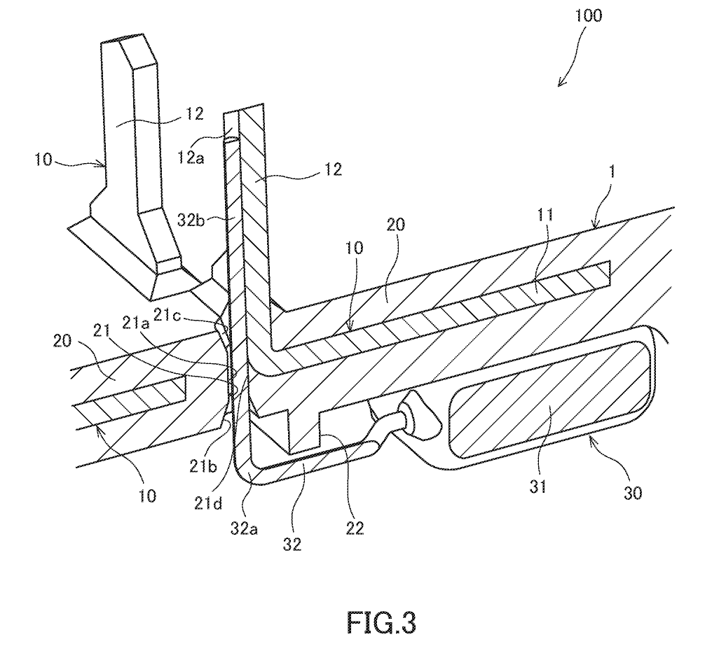

Hereinafter, a busbar unit 1 and an electronic device 100 according to an embodiment of the present invention are described with reference to the drawings. FIG. 1 is a partial plan view showing a main part of the electronic device 100. FIG. 2 is a partial bottom view showing the main part of the electronic device 100. FIG. 3 is a perspective view in section along line A-A of FIG. 1.

The electronic device 100 is applied, for example, to an ECU (Engine Control Unit) for controlling an engine of a vehicle, an ECU (Electronic Control Unit) for controlling an electric power steering device, or the like. The electronic device 100 includes the busbar unit 1 and an electronic component connected to the busbar unit 1.

The busbar unit 1 includes busbars 10 connected by welding to connection terminals 32, which are lead terminals of a ceramic capacitor 30 serving as an electronic component, and a molding part 20 formed of molding resin to cover the busbar 10. Although the ceramic capacitor 30 is described as an example of the electronic component in the present embodiment, the electronic component to be connected to the busbars 10 may be a resistor, a coil, each of various semiconductors, a power supply or the like, each having a lead terminal.

The busbar 10 is, for example, a conductor for connecting a power supply and an electronic component or connecting electronic components. The busbar unit 1 is provided with two busbars 10 so that the busbar 10 is connected to each of the two connection terminals 32 of the ceramic capacitor 30.

The busbar 10 is formed of metal with good conductivity such as copper into a flat plate. As shown in FIG. 3, the busbar 10 includes a body part 11 covered by the molding part 20 and a terminal part 12 projecting from the molding part 20 and connected to the connection terminal 32 of the ceramic capacitor 30. The terminal part 12 is formed by being bent substantially at a right angle from the body part 11. The terminal part 12 is configured such that a tip side projects from the molding part 20. The terminal part 12 is connected by welding to the connection terminal 32 of the ceramic capacitor 30. It should be noted that laser welding, fusion welding such as TIG welding, pressure welding such as resistance welding, brazing such as soldering or any other method may be used as a welding method.

As shown in FIG. 2, the ceramic capacitor 30 includes a body part 31 and the two connection terminals 32 extending in parallel from the body part 31. Each of the two connection terminals 32 of the ceramic capacitor 30 includes a bent part 32a formed by being bent as shown in FIGS. 2 and 3. The bent parts 32a are formed by being bent substantially at a right angle with the connection terminals 32 projecting in parallel from the body part 31 kept in parallel.

The molding part 20 is formed by insert molding to cover the body parts 11 of the busbars 10 by the molding resin. At this time, as described above, the molding part 20 is formed such that the tip sides of the terminal parts 12 of the busbars 10 project from the molding part 20.

The molding part 20 is provided with guide holes 21 each for guiding the connection terminal 32 of the ceramic capacitor 30 to bring the connection terminal 32 into contact with or into proximity to the terminal part 12 of the busbar 10, and a housing recess 22 for holding the body part 31 of the ceramic capacitor 30.

As shown in FIG. 3, the guide hole 21 is formed to penetrate through the molding part 20 substantially in parallel to the terminal part 12 of the busbar 10, and open near a position where the terminal part 12 of the busbar 10 projects from the molding part 20. As shown in FIGS. 1 and 2, the inner peripheral surface of the guide hole 21 is formed to have a D-shaped cross-sectional shape having a flat surface part 21d and a curved surface part 21e. Further, the flat surface part 21d of the inner peripheral surface of the guide hole 21 is formed to be continuous with a side surface 12a of the terminal part 12 connected to the connection terminal 32 of the ceramic capacitor 30 (see FIG. 3). The flat surface part 21d is formed to be continuous with the side surface 12a in this way, whereby any thin part of the molding part 20 which mold resin hardly wraps around is not present between the guide hole 21 and the terminal part 12. Thus, moldability of the molding part 20 can be ensured and the molding resin can be prevented from falling off between the guide hole 21 and the terminal part 12. It should be noted that the inner peripheral surface of the guide hole 21 may have, for example, a rectangular cross-sectional shape. Even in this case, any thin part of the molding part 20 between the guide hole 21 and the terminal part 12 can be eliminated. Further, if there is no trouble with moldability, the inner peripheral surface of the guide hole 21 may have a circular or other cross-sectional shape.

The guide hole 21 includes a guide part 21a into which the connection terminal 32 of the ceramic capacitor 30 is inserted and which guides the connection terminal 32 of the ceramic capacitor 30 to bring the connection terminal 32 into contact with or into proximity to the terminal part 12, a tapered part 21b which is open in a tapered manner on a surface of the molding part 20 on a side where the body part 31 of the ceramic capacitor 30 is provided, and a tapered part 21c which is open in a tapered manner on a surface of the molding part 20 on a side where the terminal part 12 projects.

The guide part 21a is formed into a tubular shape. A size of a cross-section of the guide part 21a is substantially equal to or slightly larger than an outer diameter of the connection terminal 32 of the ceramic capacitor 30.

Each of the tapered parts 21b, 21c is formed to be continuous with the guide part 21a and increase a diameter (increase a cross-sectional area) toward the surface of the molding part 20. Since the tapered part 21b is formed to increase the diameter toward the surface of the molding part 20, the connection terminal 32 of the ceramic capacitor 30 can be easily inserted into the guide hole 21. Further, the strength of a pin of a mold for forming the guide hole 21 can be ensured by providing the tapered parts 21b, 21c.

A tip part 32b of the connection terminal 32 of the ceramic capacitor 30 closer to the tip than the bent part 32a is inserted into the guide hole 21. At this time, the tip part 32b of the connection terminal 32 is guided along the terminal part 12 by the guide hole 21.

In welding the connection terminal 32 of the ceramic capacitor 30 and the terminal part 12 of the busbar 10, the body part 31 of the ceramic capacitor 30 is housed into the housing recess 22 while the tip part 32b of the connection terminal 32 is inserted into the guide hole 21 of the busbar unit 1. At this time, the tip part 32b of the connection terminal 32 is guided along the terminal part 12 by the guide hole 21, wherefore the tip part 32b of the connection terminal 32 and the terminal part 12 are held in contact or in proximity. Thereafter, the tip part 32b of the connection terminal 32 and the terminal part 12 are welded by the aforementioned welding method.

Since the connection terminal 32 of the ceramic capacitor 30 is processed to be bent, the connection terminal 32 may not be substantially at a right angle at the time of assembling due to springback, processing error or the like. In the present embodiment, the tip part 32b of the connection terminal 32 is positioned by the guide hole 21. That is, since the tip part 32b of the connection terminal 32 is guided along the terminal part 12 by the guide hole 21, the tip part 32b of the connection terminal 32 and the terminal part 12 can be reliably brought into contact or into proximity.

Although a case where the connection terminal 32 of the ceramic capacitor 30 is bent is described as an example in the above embodiment, the connection terminal 32 may not be bent. Further, although the guide hole 21 is formed to be open near the position where the terminal part 12 of the busbar 10 projects from the molding part 20, the guide hole 21 may be formed at any position if the connection terminal 32 of the ceramic capacitor 30 can be guided toward (brought into contact with or into proximity to) the terminal part 12 of the busbar 10.

According to the above embodiment, the following effects are exhibited.

In the busbar unit 1, the molding part 20 is formed with the guide holes 21 for guiding the connection terminals 32 of the ceramic capacitor 30 to bring the connection terminals 32 into contact with or into proximity to the terminal parts 12 of the busbars 10. In this way, the connection terminals 32 of the ceramic capacitor 30 to be welded to the terminal parts 12 of the busbars 10 can be positioned. Thus, positioning is less susceptible to dimensional and processing errors of each component as compared to the case where positioning is performed at another location such as at the body part 31. Thus, the terminal parts 12 of the busbars 10 and the connection terminals 32 of the ceramic capacitor 30 can be more precisely positioned. Further, since the connection terminals 32 of the ceramic capacitor 30 are stabilized in position, welding can be easily performed and the occurrence of a welding failure can be reduced.

Further, in the busbar unit 1, the flat surface part 21d of the guide hole 21 is formed to be continuous with the side surface 12a of the terminal part 12 to be connected to the connection terminal 32 of the ceramic capacitor 30. In this way, the connection terminal 32 of the ceramic capacitor 30 is guided along the terminal part 12 by the flat surface part 21d of the guide hole 21. Thus, the terminal part 12 of the busbar 10 and the connection terminal 32 of the ceramic capacitor 30 can be reliably brought into contact.

Since the inner peripheral surface of the guide hole 21 is formed to have the D-shaped cross-sectional shape having the flat surface part 21d and the curved surface part 21e and the flat surface part 21d is formed to be continuous with the side surface 12a of the terminal part 12 in the busbar unit 1, any thin part of the molding part 20 due to difficulty of the molding resin to penetrate can be eliminated between the guide hole 21 and the terminal part 12. Thus, moldability of the molding part 20 can be ensured and the molding resin can be prevented from falling off.

Since the guide hole 21 includes the tapered part 21b in the busbar unit 1, the connection terminal 32 of the ceramic capacitor 30 can be easily inserted into the guide hole 21.

In the busbar unit 1, the part (tip part 32b) of the connection terminal 32 of the ceramic capacitor 30 closer to the tip than the bent part 32a is inserted into the guide hole 21. When the connection terminal 32 of the ceramic capacitor 30 is bent, dimensional errors are likely to occur due to springback and the like. Thus, by guiding the part (tip part 32b) of the connection terminal 32 of the ceramic capacitor 30 closer to the tip than the bent part 32a by the guide hole 21, the terminal part 12 of the busbar 10 and the connection terminal 32 of the ceramic capacitor 30 can be more precisely positioned.

Further, the guide holes 21 are formed in the molding part 20 in the busbar unit 1. Since the molding part 20 is formed to cover the busbars 10, the molding part 20 is thicker than the busbars 10. Thus, by forming the guide holes 21 in the molding part 20, the guide holes 21 can be made longer as compared to the case where guide holes are formed in the busbars 10. In this way, the connection terminals 32 of the ceramic capacitor 30 can be more precisely guided (positioned).

The configuration, functions and effects of the embodiment of the present invention configured as described above are summarized.

The busbar unit 1 includes the busbars 10 connected by welding to the connection terminals 32 of the electronic component (ceramic capacitor 30) and the molding part 20 formed of the molding resin to cover the busbars 10, the busbar 10 includes the body part 11 covered by the molding part 20 and the terminal part 12 projecting from the molding part 20 and connected to the connection terminal 32 of the electronic component (ceramic capacitor 30), and the molding part 20 is formed with the guide holes 21 to guide the connection terminals 32 of the electronic component (ceramic capacitor 30) to bring the connection terminals 32 into contact with or into proximity to the terminal parts 12.

Since the connection terminals 32 of the ceramic capacitor 30 to be brought into contact with the terminal parts 12 of the busbars 10 can be positioned in this configuration, positioning is less susceptible to dimensional and processing errors of each component. Thus, the terminal parts 12 of the busbars 10 and the connection terminals 32 of the ceramic capacitor 30 can be more precisely positioned.

In the busbar unit 1, a part (flat surface part 21d) of the inner peripheral surface of the guide hole 21 is formed to be continuous with the side surface 12a of the terminal part 12 connected to the connection terminal 32 of the electronic component (ceramic capacitor 30).

Since the part (flat surface part 21d) of the inner peripheral surface of the guide hole 21 is formed to be continuous with the side surface 12a of the terminal part 12 connected to the connection terminal 32 of the electronic component (ceramic capacitor 30) in this configuration, the connection terminal 32 of the electronic component (ceramic capacitor 30) is guided along the terminal part 12 by the guide hole 21. In this way, the terminal part 12 of the busbar 10 and the connection terminal 32 of the electronic component (ceramic capacitor 30) can be reliably brought into contact.

In the busbar unit 1, the inner peripheral surface of the guide hole 21 has the D-shaped cross-sectional shape having the flat surface part 21d and the curved surface part 21e , and the flat surface part 21d is formed to be continuous with the side surface 12a.

Since any thin part of the molding part 20 which mold resin hardly wraps around is not present between the guide hole 21 and the terminal part 12, moldability can be ensured and the molding resin can be prevented from falling off.

In the busbar unit 1, the guide hole 21 includes the guide part 21a into which the connection terminal 32 of the electronic component (ceramic capacitor 30) is inserted and which guides the connection terminal 32 of the electronic component (ceramic capacitor 30) to bring the connection terminal 32 into contact with or into proximity to the terminal part 12, and the tapered part 21b which is open in a tapered manner on the surface of the molding part 20 on the side where the body part 31 of the electronic component (ceramic capacitor 30) is provided.

Since the tapered part 21b is formed to increase the diameter toward the surface of the molding part 20 in this configuration, the connection terminal 32 of the electronic component (ceramic capacitor 30) can be easily inserted into the guide hole 21.

The electronic device 100 includes the busbar unit 1 and the electronic component (ceramic capacitor 30), the connection terminal 32 of the electronic component (ceramic capacitor 30) includes the bent part 32a formed by being bent, and the part of the connection terminal 32 of the electronic component (ceramic capacitor 30) closer to the tip than the bent part 32a is inserted into the guide hole 21.

In this configuration, the part of the connection terminal 32 of the ceramic capacitor 30 closer to the tip than the bent part 32a is inserted into the guide hole 21. When the connection terminal 32 of the ceramic capacitor 30 is bent, dimensional errors are likely to occur due to springback and the like. Thus, by guiding the part of the connection terminal 32 of the ceramic capacitor 30 closer to the tip than the bent part 32a by the guide hole 21, the terminal part 12 of the busbar 10 and the connection terminal 32 of the ceramic capacitor 30 can be more precisely positioned.

Embodiments of this invention were described above, but the above embodiments are merely examples of applications of this invention, and the technical scope of this invention is not limited to the specific constitutions of the above embodiments.

This application claims priority based on Japanese Patent Application No. 2016-68241 filed with the Japan Patent Office on Mar. 30, 2016, the entire contents of which are incorporated into this specification.

1. A busbar unit, comprising:
a busbar connected by welding to a connection terminal of an electronic component; and
a molding part formed of molding resin to cover the busbar;
wherein
the busbar includes:
a body part covered by the molding part; and
a terminal part projecting from the molding part and connected to the connection terminal of the electronic component; and
the molding part is formed with a guide hole to guide the connection terminal of the electronic component to bring the connection terminal into contact with or into proximity to the terminal part.

2. The busbar unit according to claim 1, wherein:
a part of an inner peripheral surface of the guide hole is formed to be continuous with a side surface of the terminal part connected to the connection terminal of the electronic component.

3. The busbar unit according to claim 2, wherein:
the inner peripheral surface of the guide hole has a D-shaped cross-sectional shape having a flat surface part and a curved surface part; and
the flat surface part is formed to be continuous with the side surface.

4. The busbar unit according to claim 1, wherein the guide hole includes:
a guide part into which the connection terminal of the electronic component is inserted to guide the connection terminal of the electronic component to bring the connection terminal into contact with or into proximity to the terminal part; and
a tapered part open in a tapered manner on a surface of the molding part on a side where a body part of the electronic component is provided.

5. An electronic device, comprising:
the busbar unit according to claim 1; and
the electronic component;
wherein:
the connection terminal of the electronic component includes a bent part formed by being bent; and
a part of the connection terminal of the electronic component closer to a tip than the bent part is inserted into the guide hole.
